(19) United States
(12) Patent Application Publication
(10) Pub. No.: US 2008/0303622 A1
(43) Pub. Date: Dec. 11, 2008

(54) SPIRAL INDUCTOR

(75) Inventors: Sang Gyu PARK, Suwon (KR); Yu Sin Kim, Daejeon (KR); Kwang Du Lee, Jeollanam-Do (KR); Dong Ok Han, Suwon (KR); Jeong Hoon Kim, Suwon (KR); Moon Suk Jeong, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., Suwon (KR)

(21) Appl. No.: 12/129,381

(22) Filed: May 29, 2008

(30) Foreign Application Priority Data
Jun. 11, 2007 (KR) 10-2007-56853

(51) Int. Cl. H01F 5/00

(52) U.S. Cl. 336/200

(57) ABSTRACT

There is provided a spiral inductor including an insulation board formed into a flat-plate shape; a conductive pattern having a spiral shape and formed at least one surface of the insulation board, wherein the conductive pattern varies in line width according to a distance from one end of the conductive pattern forming a spiral.

### CROSS-REFERENCE TO RELATED APPLICATIONS

This application claims the priority of Korean Patent Application No. 2007-56853 filed on Jun. 11, 2007, in the Korean Intellectual Property Office, the disclosure of which is incorporated herein by reference.

### BACKGROUND OF THE INVENTION

1. Field of the Invention

The present invention relates to a spiral inductor, and more particularly, to an inductor having a spiral conductive pattern forming the inductor that has line width varying in a length direction of the spiral.

2. Description of the Related Art

FIG. 1 is a view illustrating a structure of a spiral inductor according to the related art.

Referring to FIG. 1, a conductive pattern 12 having a spiral structure is formed on an insulation board 11.

The insulation board 11 is formed of a printed wiring board or the like. The conductive pattern 12 that forms an inductor and has the spiral shape is formed at one surface of the insulation board 11.

The conductive pattern 12 that forms the inductor has a constant width in a length direction of the spiral shape with the loops of the spiral being a constant distance apart.

Further, one end 12a positioned at the edge of the conductive pattern 12 and the other end positioned at the center thereof may be connected to input and output terminals, respectively. When a current flows from the one terminal 12a, the current flows in directions indicated by arrows A1, A2, A3, and A4 toward the other terminal 12b.

As described above, when the conductive pattern of the spiral inductor has the constant line width, and the spiral of the conductor has the loops at the constant distance apart, the inductance of the inductor may be reduced. That is, when the current is supplied to the spiral inductor, the current flows through the loops of the spiral of the conductive pattern 12 forming the inductor that face each other on the basis of a center of the conductive pattern 12 along opposite directions (A1 and A3, and A2 and A4). The loops of the spiral of the conductor that face each other are affected by magnetic lines of force generated around each other to thereby reduce the inductance of the inductor.

As such, the spiral inductor according to the related art has a structure in which the inductor has the constant width and the spiral loops of the conductive pattern are affected by the magnetic lines of force generated around each other. This causes reductions in inductance and quality (Q) factor.

### SUMMARY OF THE INVENTION

An aspect of the present invention provides a spiral inductor that has a high quality factor by preventing deterioration in performance caused by interaction between loops of a spiral conductive pattern.

According to an aspect of the present invention, there is provided a spiral inductor including an insulation board formed into a flat-plate shape; a conductive pattern having a spiral shape and formed at least one surface of the insulation board, wherein the conductive pattern varies in line width according to a distance from one end of the conductive pattern forming a spiral.

The conductive pattern may be formed by alternating a first region decreasing in line width and a second region increasing in line width according to distances from one end of the conductive pattern forming the spiral.

Each of the first region and the second region of the conductive pattern may form one turn.

The conductive patterns may be formed at both surfaces of the insulation board and have ends thereof connected to each other by a conductive via hole formed through the insulation board.

At least portions of the conductive patterns formed at both surfaces of the insulation board may overlap with each other.

According to another aspect of the present invention, there is provided a spiral inductor including: a plurality of conductive patterns having a spiral shape; at least one insulation board formed between the conductive patterns, wherein the plurality of conductive patterns vary in line width according to distances from ends of the individual conductive patterns forming spirals and are connected in series with each other by a conductive via hole formed through the insulation board.

Each of the plurality of conductive patterns may be formed by alternating a first region decreasing in line width and a second region increasing in line width according to the distance from one end of the conductive pattern forming the spiral.

Each of the first region and the second region of each of the plurality of conductive patterns may form one turn.

At least portions of the plurality of conductive patterns may overlap with each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a graph illustrating a structure of a spiral inductor according to the related art.

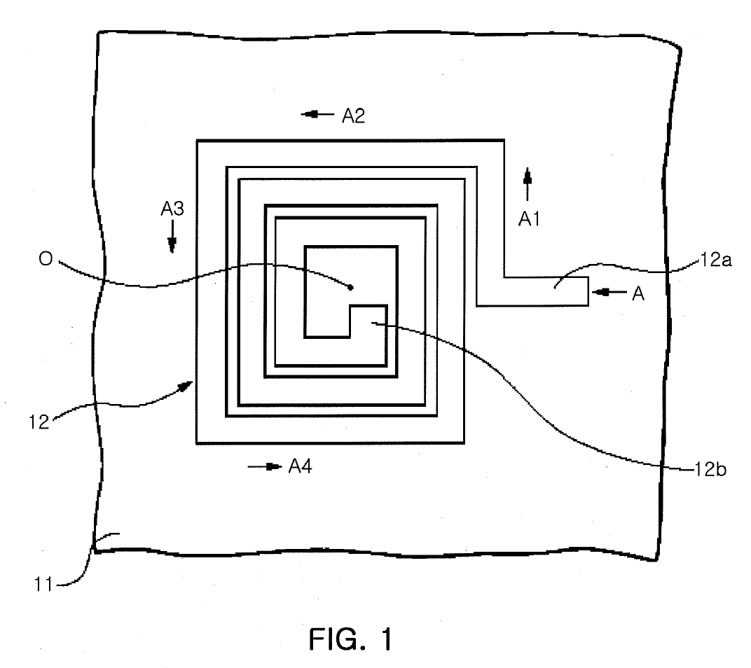

FIG. 2 is a view illustrating a structure of a spiral inductor according to an exemplary embodiment of the present invention.

FIG. 3 is a view illustrating a structure of a spiral inductor according to another exemplary embodiment of the present invention.

FIG. 4 is an exploded perspective view illustrating a spiral inductor according to still another exemplary embodiment of the present invention.

FIG. 5 is a graph illustrating a Q value of a spiral inductor according to the exemplary embodiment of the present invention.

### DETAILED DESCRIPTION OF THE PREFERRED EMBODIMENT

Exemplary embodiments of the present invention will now be described in detail with reference to the accompanying drawings.

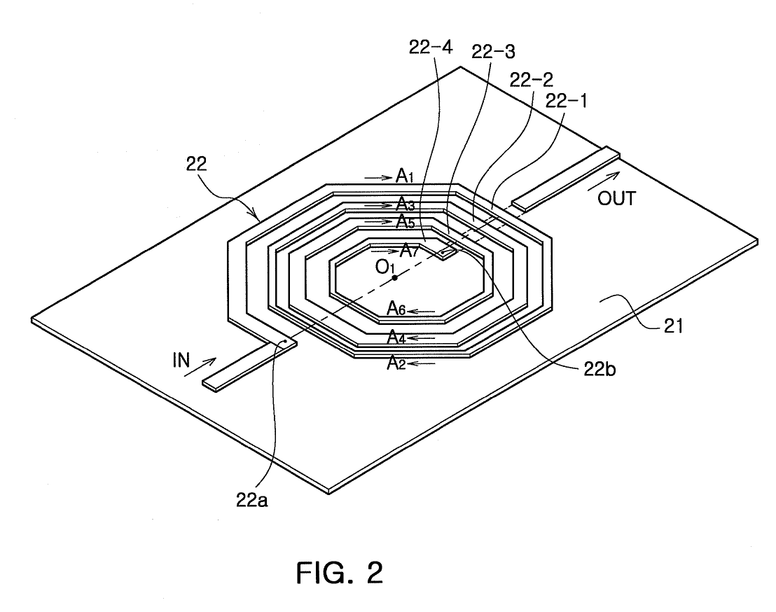

FIG. 2 is a view illustrating a structure of a spiral inductor according to an exemplary embodiment of the invention.

Referring to FIG. 2, a spiral inductor according to an exemplary embodiment of the invention includes an insulation board 21 and a conductive pattern 22. The conductive pattern 22 having a spiral shape is formed at the insulation board.

The spiral conductive pattern 22 may vary in line width according to a distance from the one end 22a of the spiral conductive pattern.

The spiral conductive pattern 22 may be formed by alternating a first region increasing in line width and a second region decreasing in line width.

In this embodiment, the spiral conductive pattern may have a rotation number (turn number) of 3.5. The spiral conductive pattern 22 may include a first line 22-1 decreasing in line width, a second line 22-2 increasing in line width, a third line 22-3 decreasing in line width, and a fourth line 22-4 increasing in line width according to distances from the one end 22a of the conductive pattern.

The first line 22-1 has one end 22a that may be connected to an input terminal IN through which a current can be supplied to the conductive pattern. The fourth line 22-4 has one end 22b that may be connected to an output terminal OUT.

The input terminal IN may be formed on the same plane as the conductive pattern. The output terminal OUT may be formed on a different plane from that of the conductive pattern and be connected to the fourth line 22-4 through a conductive via hole.

The first line 22-1 and the third line 22-3 correspond to second regions that decrease in line width according to the distances from the one end 22a of the conductive pattern, and the second line 22-2 and the fourth line 22-4 correspond to the first regions that increase in line width along a length direction.

In this embodiment, the spiral conductive pattern formed by alternating a configuration in which the line width increases and a configuration in which line width decreases according to the distances from the one end 22a of the spiral conductive pattern. Therefore, it is possible to solve the above-described problems, that is, the reductions in inductance and Q factor due to interaction between the magnetic lines of force generated around the loops of the spiral conductive pattern of the spiral inductor having the constant width.

That is, when the current is supplied to the conductive pattern 22, the current flows in order of directions A₁, A₂, A₃, A₄, A₅, A₆, and A₇. The current flows through the loops of the spiral conductive pattern 22 that face each other on the basis of a center point O₁ of the spiral conductive pattern 22 in opposite directions (A₁ and A₂, A₃ and A₄, and A₅ and A₆). However, the loops of the spiral conductive pattern do not have the same line widths as each other but gradually increase or decrease. Since the loops are positioned at varying distances from the center point O₁, they may be affected less by magnetic lines of force generated around each other, and the inductance may increase.

As such, when the inductance of the inductor formed of the spiral conductive pattern 22 increases, the Q factor also increases.

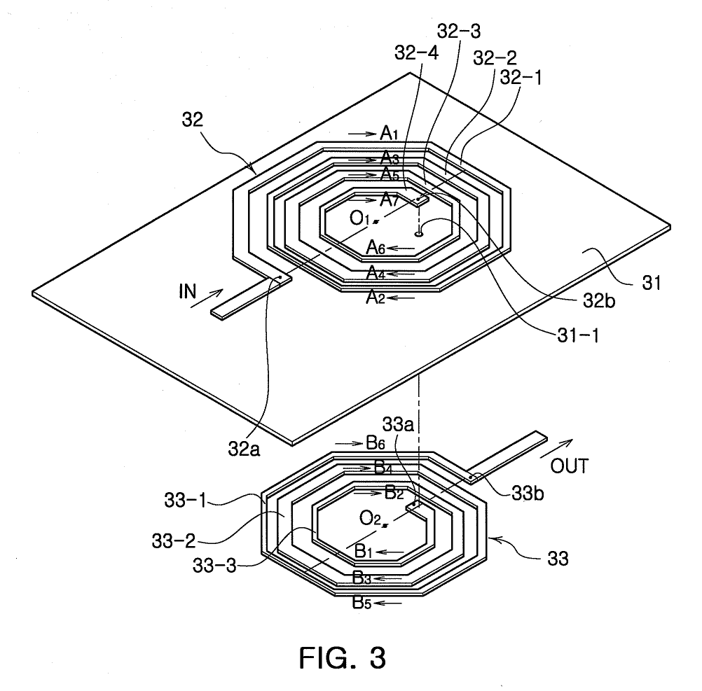

FIG. 3 is an exploded perspective view of a spiral inductor according to another exemplary embodiment of the invention.

Referring to FIG. 3, a spiral inductor according to this embodiment includes an insulation board 31, a first conductive pattern 32, and a second conductive pattern 33. The first and second conductive patterns 32 and 33 are formed at both surfaces of the insulation board 31.

The insulation board 31 may be formed of ferromagnetic ceramics, such as ferrite having a predetermined dielectric constant, or non-ferromagnetic ceramics.

The first conductive pattern 32 and the second conductive pattern 33 may vary in line width according to distances from ends 32a and 33a of the conductive patterns forming a spiral, respectively.

Each of the spiral first conductive pattern 32 and the spiral second conductive pattern 33 may be formed by alternating a first region increasing in line width and a second region decreasing in line width according to distances from the one end of the conductive pattern.

In this embodiment, the first conductive pattern 32 may have a rotation number (turn number) of 3.5. The first conductive pattern 32 may include a first line 32-1 decreasing in line width, a second line 32-2 increasing in line width, a third line 32-3 decreasing in line width, and a fourth line 32-4 increasing in line width.

The first conductive pattern 32 may have one end 32a that may be connected to an input terminal IN through which a current can be supplied to the conductive pattern 32. The first conductive pattern 32 may have the other end 32b that may be connected to one end 33a of the second conductive pattern through a conductive via hole 31-1 formed in the insulation board 31.

The second conductive pattern 33 may have a rotation number (turn number) of 3. The second conductive pattern 33 may include a first line 33-1 decreasing in line width, a second line 33-2 increasing in line width, and a third line 33-3 decreasing in line width according to a distance from the one end 33a of the conductive pattern.

The one end 33a of the second conductive pattern is connected to the other end 32b of the first conductive pattern through the conductive via hole 33-1 formed in the insulation board 31. The other end 33b of the second conductive pattern may be connected to the output terminal OUT of the current.

In this embodiment, the input terminal IN may be formed on the same plane as the first conductive pattern, and the output terminal OUT may be formed on the same plane as the second conductive pattern.

In this embodiment, each of the first and second conductive patterns is formed by alternating a configuration in which line width increases and a configuration in which line width decreases according to the distances from each of the ends 32a and 33a of the conductive pattern forming the spiral. Therefore, it is possible to solve the above-described problems, that is, the reductions in inductance and Q factor due to interaction between the magnetic lines of force generated around the loops of the spiral conductive pattern of the spiral inductor having the constant width.

That is, the current flows through the first conductive pattern 32 in order of directions A₁, A₂, A₃, A₄, A₅, A₆, and A₇. The current flows through the loops of the spiral conductive pattern that face each other on the basis of a center point O₁ of the spiral conductive pattern 32 in opposite directions A₁ and A₂, A₃ and A₄, and A₅ and A₆. However, the line widths are the same as each other but decrease or increase gradually. Therefore, since the distances from the center point O₁ are the same as each other, the loops of the conductive pattern that face each other on the basis of the center point O₁ are affected less by magnetic lines of force generated around each other, and the inductance of the conductive pattern may increase.

The current flowing through the first conductive pattern 32 is supplied to the second conductive pattern 33 through the conductive via hole 31-1. The current flows through the second conductive pattern 33 in order of directions B₁, B₂, B₃, B₄, B₅, and B₆.

Like the first conductive pattern, the current flows through the loops of the second conductive pattern 33 having the spiral shape that face each other on the basis of a center point O₂ of the second conductive pattern 33 having the spiral shape in opposite directions B₁ and B₂, B₃ and B₄, and B₅ and B₆. Therefore, the loops of the conductive pattern that face each other on the basis of the center point O₂ are affected less by magnetic lines of force generated around each other, and the inductance of the second conductive pattern may increase.

The center point O₁ of the first conductive pattern 32 and the center point O₂ of the second conductive pattern 33 may be positioned along the same vertical line.

The first conductive pattern 32 and the second conductive pattern 33 may partially overlap with each other. Further, the current may flow through the overlapping portion between the first and conductive patterns in the same direction.

The loops of each of the two spirals are a distance apart so that outermost loops of the spirals correspond to each other.

In this embodiment, the first line 32-1 of the first conductive pattern and the first line 33-1 of the second conductive pattern partially overlap with each other, and the current may flow through the overlapping portion in the same direction (A₁ and B₆, and A₂ and B₅).

Further, the second line 32-2 of the first conductive pattern and the second line 33-2 of the second conductive pattern partially overlap with each other, and the current may flow through the overlapping portion in the same direction (A₃ and B₄, and A₄ and B₃). The third line 32-3 of the first conductive pattern and the third line 33-3 of the second conductive pattern partially overlap with each other, and the current may flow through the overlapping portion in the same direction (A₅ and B₂, and A₆ and B₁).

As such, since at least portions of the spiral conductive patterns formed at both surfaces of the insulation board overlap with each other, and the current flows through the overlapping portions in the same direction, an electrical length of the inductor with the same area can be increased to thereby reduce the size of the inductor.

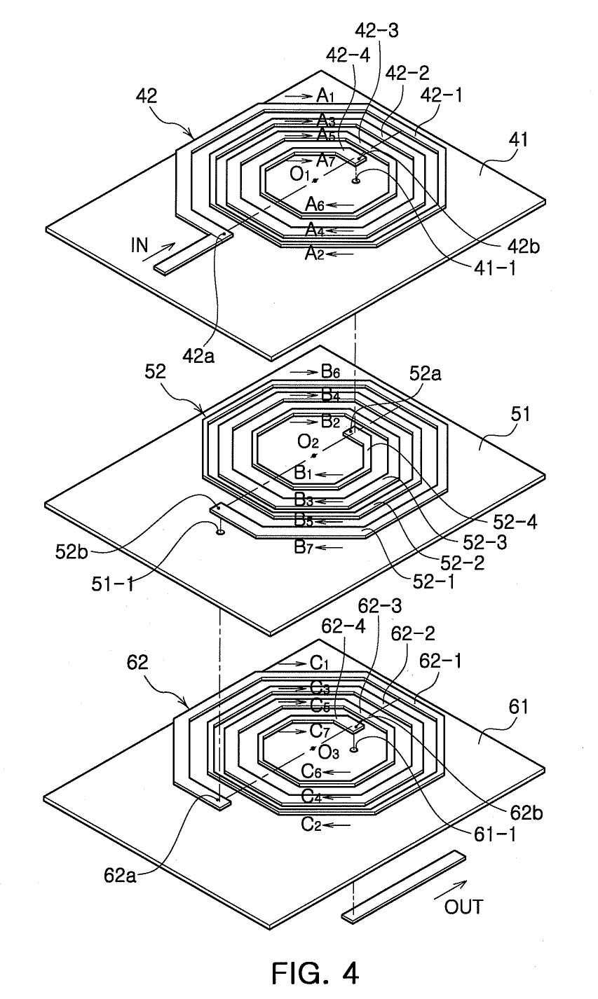

FIG. 4 is an exploded perspective view illustrating a spiral inductor according to another exemplary embodiment of the present invention.

Referring to FIG. 4, a spiral inductor according to this embodiment may include a plurality of conductive patterns 42, 52, and 62 each having a spiral shape and a plurality of insulation boards 41, 51, and 61 each formed between the conductive patterns.

In this embodiment, the insulation boards 41, 51, and 61 may include a first insulation board 41, a second insulation board 51, and a third insulation board 61. The first, second, and third insulation boards 41, 51, and 61 may include conductive via holes 41-1, 51-1, and 61-1 formed in the insulation boards, respectively. Each of the conductive via holes 41-1, 51-1, and 61-1 electrically connects the conductive patterns formed at upper and lower surfaces of each of the insulation boards.

In this embodiment, the plurality of spiral conductive patterns may include the first conductive pattern 42, the second conductive pattern 52, and the third conductive pattern 62. Each of the conductive patterns 42, 52, and 62 may vary in line width along a length direction of conducting wires forming the spiral shape.

Each of the first, second, and third conductive patterns 42, 52, and 62 having the spiral shapes may be formed by alternating a first region increasing in line width and a second region decreasing in line width according to distances from one end of each of the conductive patterns.

In this embodiment, the first conductive pattern 42 may have a rotation number (turn number) of 3.5. The first conductive pattern 42 may include a first line 42-1 decreasing in line width, a second line 42-2 increasing in line width, a third line 42-3 decreasing in line width, and a fourth line 42-4 increasing in line width according to distances from one end 42a of the conductive pattern 42.

The first conductive pattern 42 has the one end 42a that may be connected to an input terminal IN through which a current can be supplied to the conductive pattern. The first conductive pattern 42 also has the other end 42b that may be connected to one end 52a of the second conductive pattern by a conductive via hole 41-1 formed in the first insulation board 41.

The second conductive pattern 52 may have a rotation number (turn number) of 3.5. The second conductive pattern 52 may include a first line 52-1 decreasing in line width, a second line 52-2 increasing in line width, a third line 52-3 decreasing in line width, and a fourth line 52-4 increasing in line width according to a distance from the one end 52a of the conductive pattern.

The second conductive pattern has the one end 52a that may be connected to the other end 42b of the first conductive pattern by the conductive via hole 41-1. The other end 52b of the second conductive pattern may be connected to one end 62a of the third conductive pattern by the conductive via hole 51-1 formed in the second insulation board.

The third conductive pattern 62 may have a rotation number (turn number) of 3.5. The third conductive pattern 62 may include a first line 62-1 decreasing in line width, a second line 62-2 increasing in line width, a third line 62-3 decreasing in line width, and a fourth line 62-4 increasing in line width according to distances from the one end 62a of the conductive pattern.

The one end 62a of the third conductive pattern may be connected to the one end 52b of the second conductive pattern by the conductive hole 51-1 of the conductive via hole 51-1. The other end of the third conductive pattern may be connected to an output terminal OUT through the conductive via hole 61-1 formed in the third insulation board.

According to the embodiment of the invention, the conductive pattern forming the inductor may be formed by alternating a configuration in which line width increases and a configuration in which line width decreases according to distances from one end of the spiral conductive pattern. Therefore, it is possible to solve the problems of the reductions in inductance and Q factor due to interaction between the magnetic lines of force generated around the loops of the spiral conductive pattern of the spiral inductor having the constant width.

That is, the current flows through the first conductive pattern 42 in order of directions A₁, A₂, A₃, A₄, A₅, A₆, and A₇. The current flows through the loops of the conductive pattern 42 that face each other on the basis of a center point O₁ of the spiral conductive pattern 42 in opposite directions (A₁ and A₂, A₃ and A₄, and A₅ and A₆). However, since the loops have line widths that are not the same as each other but increase or decrease gradually, distances from the center point O₁ are different from each other. Therefore, the loops are affected less by magnetic lines of force generated around each other, and the inductance of the first conductive pattern may increase.

The current flowing through the first conductive pattern 42 is supplied to the second conductive pattern 52 through the conductive via hole 41-1. The current flows through the second conductive pattern in order of directions B₁, B₂, B₃, B₄, B₅, B₆, and B₇.

The current flowing through the second conductive pattern 52 is supplied to the third conductive pattern 62 through the conductive via hole 51-1. The current flows through the third conductive pattern in order of directions C₁, C₂, C₃, C₄, C₅, C₆, and C₇.

In the same manner, the current may flow through the loops of each of the second and third conductive patterns 52 and 62 having the spiral shape that face each other on the basis of the center point (O₂ or O₃) thereof in opposite directions (B₁ and B₂, B₃ and B₄, and B₅ and B₆ or C₁ and C₂, C₃ and C₄, and C₅ and C₆). Therefore, the influence of the loops of the spiral conductive pattern that face each other on the basis of each of the center points O₂ and O₃ are affected less by magnetic lines generated around each other and the inductance of the spiral conductive pattern may increase.

The center point O₁ of first conductive pattern 42, the center point O₂ of the second conductive pattern 52, and the center point O₃ of the third conductive pattern 62 may be positioned on the same vertical line.

The first conductive pattern 42, the second conductive pattern 52, and the third conductive pattern 62 may partially overlap with each other. Further, the current may flow through the overlapping portions between the conductive patterns in the same direction.

The loops of each of the three spirals are a constant distance apart so that outermost loops of the spirals correspond to each other.

In this embodiment, the first line 42-1 of the first conductive pattern, the first line 52-1 of the second conductive pattern, and the first line 62-1 of the third conductive pattern partially overlap with each other, and the directions (A₁, B₆, and C₁) in which the current flows through the overlapping portions may be the same as each other.

Further, the second line 42-2 of the first conductive pattern, the second line 52-2 of the second conductive pattern, and the second line 62-2 of the third conductive pattern partially overlap with each other. The directions (A₃, B₄, C₃) in which the current flows through the overlapping portions may be the same as each other. The third line 42-3 of the first conductive pattern, the third line 52-3 of the second conductive pattern, and the third line 62-3 of the third conductive pattern partially overlap with each other, and the directions (A₅, B₂, C₅) in which the current flows through the overlapping portions may be the same as each other.

As such, the plurality of spiral conductive patterns and the plurality of insulation boards are laminated, at least portions of the laminated spiral conductive patterns overlap with each other, and the current flows through the overlapping portions in the same direction. Therefore, the electrical length of the inductor with the same area can be increased to thereby reduce the inductance.

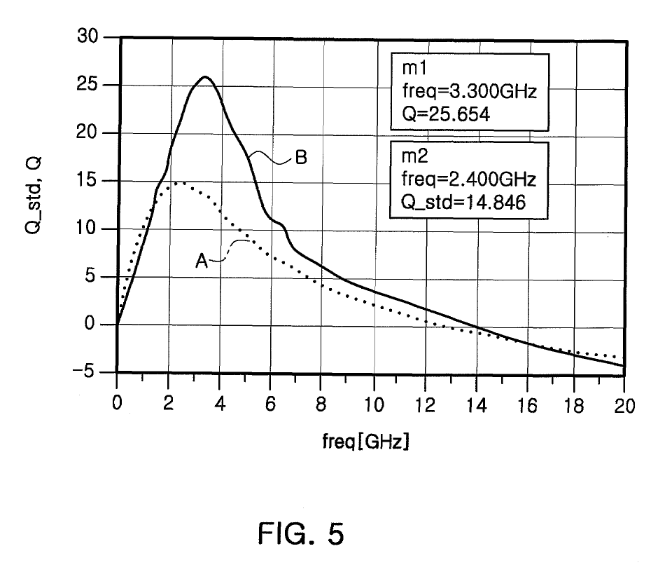

FIG. 5 is a graph illustrating a Q value of a spiral inductor according to an exemplary embodiment of the invention.

Referring to FIG. 5, a curve A indicates a Q value according to frequency of a spiral inductor according to the related art, and a curve B indicates a Q value according to frequency of the spiral inductor according to the embodiment of the invention.

In this embodiment, the spiral inductor according to the related art includes eight layers of conductive patterns each having an area of 346×204 μm² and a line width of 9 μm. An innermost loop of the spiral conductive pattern has a diameter of 120 μm, and the loops of the spiral are a distance of 3 μm apart. The spiral has a turn number of 3.5.

In the graph of FIG. 5, the spiral inductor according to the embodiment of the invention has a maximum Q value of approximately 21, and the inductor according to the related art has a maximum Q value of approximately 15. Therefore, according to the embodiment of the invention, the spiral inductor according to the embodiment of the invention increases characteristics by approximately 30% than the spiral inductor having the constant line width according to the related art.

As set forth above, according to the exemplary embodiments of the invention, it is possible to manufacture a spiral inductor that can be reduced in size as compared with the spiral inductor according to the related art and has higher inductance and a higher Q for the same area.

While the present invention has been shown and described in connection with the exemplary embodiments, it will be apparent to those skilled in the art that modifications and variations can be made without departing from the spirit and scope of the invention as defined by the appended claims.

1. A spiral inductor comprising:
an insulation board formed into a flat-plate shape;
a conductive pattern having a spiral shape and formed at least one surface of the insulation board,
wherein the conductive pattern varies in line width according to a distance from one end of the conductive pattern forming a spiral.

2. The spiral inductor of claim 1, wherein the conductive pattern is formed by alternating a first region decreasing in line width and a second region increasing in line width according to distances from one end of the conductive pattern forming the spiral.

3. The spiral inductor of claim 2, wherein each of the first region and the second region of the conductive pattern forms one turn.

4. The spiral inductor of claim 1, wherein the conductive patterns are formed at both surfaces of the insulation board and have ends thereof connected to each other by a conductive via hole formed through the insulation board.

5. The spiral inductor of claim 4, wherein at least portions of the conductive patterns formed at both surfaces of the insulation board overlap with each other.

6. A spiral inductor comprising:
a plurality of conductive patterns having a spiral shape;
at least one insulation board formed between the conductive patterns,
wherein the plurality of conductive patterns vary in line width according to distances from ends of the individual conductive patterns forming spirals and are connected in series with each other by a conductive via hole formed through the insulation board.

7. The spiral inductor of claim 6, wherein each of the plurality of conductive patterns is formed by alternating a first region decreasing in line width and a second region increasing in line width according to the distance from one end of the conductive pattern forming the spiral.

8. The spiral inductor of claim 7, wherein each of the first region and the second region of each of the plurality of conductive patterns forms one turn.

9. The spiral inductor of claim 6, wherein at least portions of the plurality of conductive patterns overlap with each other.
